(19) United States
(12) Patent Application Publication
(10) Pub. No.: US 2008/0113541 A1
(43) Pub. Date: May 15, 2008

(54) Three-way to One-way Light Bulb Adaptor

(76) Inventor: Albert E. Adams, Lyndonville, VT (US)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 11/940,737

(22) Filed: Nov. 15, 2007

Related U.S. Application Data
(60) Provisional application No. 60/859,316, filed on Nov. 15, 2006.

(51) Int. Cl. F21V 23/06

(52) U.S. Cl. 439/236; 313/318.01

(57) ABSTRACT

An electrical contact modifier is configured to allow the use of a “single-element” medium base light bulb in a three-way lamp holder/switch. The device allows the three-way switch to replicate the “OFF-ON” functionality of a standard one-way light switch. The apparatus may be implemented as a single-socket bulb extender, or alternately, a device that is concealed within the lamp holder body and/or attached to the base of a one-way “single-element” light bulb.

This application claims priority from provisional application 60/859,316 filed Nov. 15, 2006.

### FIELD OF THE INVENTION

The invention relates to electric light fixtures, and more particularly to three way bulbs and sockets.

### BACKGROUND OF THE INVENTION

There is a desire on the part of many consumers to use a “single-element” bulb in a three-way light fixture. For example, many ecologically-minded persons prefer to use the more efficient compact fluorescent bulbs in place of traditional wire filament incandescent bulbs. Three-way versions of compact fluorescent bulbs are difficult to find and expensive. In other cases, a consumer may wish to have only a single level of illumination from a lamp fitted with a three-way light socket.

A three-way socket has a common connection, usually all or part of the threaded portion of the base receptacle. Additionally, there are two connections in the bottom of the base designed to connect, respectively, a tip connection and a ring connection on the three-way bulb. In the off (or first) position of the power switch, no power is sent to any connection. In the second position, power is sent to the ring, thus making a powered connection through the lighting element to the common connection. In the third position, power is provided to the tip connection, and not to the ring, thus lighting a second element typically of higher power. In the fourth position, power is provided to both the ring and the tip, thus giving the combined light output of both the bulb-lighting elements.

A “single-element” (or one-way) bulb has no ring connection. A problem with using a single-way (one level of illumination) bulb in a three-way socket is that as the power switch is turned, the illumination pattern will be off-off-on-on rather than the desired off-on. This can be a nuisance.

What is needed is a simple, consumer-friendly device that will adapt a three-way light socket to operate a “single-element” bulb in the desired of-on configuration.

### BRIEF DESCRIPTION OF THE INVENTION

An object of the present invention is to provide a means of modifying a three-way lamp holder/switch to accommodate a “single-element” compact fluorescent or other type of medium-base light bulb, using a simple, durable device that can fit within the confines of a typical three-way household lamp without compromising utility or safety, while at the same time duplicating the functionality of an “OFF-ON” type of switching system.

In one embodiment, a three-way to one-way bulb adapter according to the principles of the present invention is realized in an adapter having a top with a standard one-way bulb socket and a bottom being a modified three-way bulb base. The ring of the base is wired to the tip of the socket, and the tip of the base has no connection. The common of the base and the common of the socket are connected. Since the ring connection of the base is powered on-off-on-off as the switch in a three-way lamp socket is turned, the result is to power a one-way bulb screwed into the adapter in the same sequence.

In another embodiment, a disc shaped button adapter for insertion into a three-way lamp socket is made from a disc of non-conductive material with a notch in the disc designed to fit over the ring connection of a three-way bulb socket. The disk has a connector means which connects the three-way bulb ring connector to a tip connector on a one-way bulb when the disc adapter is inserted into a three-way bulb socket and a one-way bulb is then inserted into the same socket. The disc adapter electrically isolates the tip connector of the three-way lamp socket.

In yet another embodiment, the adapter is made from a ring-shaped non-conductive material having a flexible electrically conductive interior. The adapter is sized to fit over the tip and ring connector of a standard three-way socket, and has a non-conductive pip on the underside so as to electrically isolate the tip connector of a three-way base. The conductive interior makes electrical connection between the ring connector of a three-way socket and a light bulb inserted into the socket with the adapter in place between the two.

### BRIEF DESCRIPTION OF THE DRAWINGS

FIG. 1 is a bottom view of a three-way to one-way bulb adapter.

FIG. 2 is a side view of a three-way to one-way bulb adapter.

FIG. 3 is a top down view of a three-way to one-way bulb adapter.

FIG. 4 is a view of a one-way light bulb being inserted into a three-way to one-way bulb adapter.

FIG. 5 is a schematic wiring diagram of a three-way to one-way bulb adapter.

FIG. 6 is a side view of a three-way to one-way bulb button adapter.

FIG. 7 is a top-down view of a three-way to one-way bulb button adapter.

FIG. 7A is a top-down view of a standard three-way bulb socket (prior art).

FIG. 8 is a side view of a one-way bulb positioned above a button adapter.

FIG. 8A is a top-down view of a three-way to one-way bulb button adapter in place in a standard three-way bulb socket.

FIG. 9 is a side view of another embodiment of a three-way to one-way button adapter.

FIG. 10 is a top view of a three-way to one-way button adapter.

FIG. 11 is a bottom view of a three-way to one-way button adapter.

FIG. 12 is a side view showing a button adapter positioned below a standard one-way bulb as it would be in use (socket not shown).

### DETAILED DESCRIPTION

A “single-element” light bulb, for the purposes of this document, refers to one which is capable of a single level of illumination when energized. Any type of medium-base light bulb could be used. However, a need exists to utilize compact fluorescent lamps (CFLs) and LED bulbs.

A three-way lamp holder/switch is often found in many table and floor lamps. When combined with what is typically an incandescent three-way light bulb, three levels of illumination are produced by the lamp. The standard three-way lamp holder has four switch positions: off, low, medium, and high. By utilizing the outside of the light bulb's screw-in base as a common electrical ground, with two concentric electrical contacts (called, respectively, tip and ring) on the bulb's male base, the three-way lamp holder enables independent or simultaneous activation of the two separate filaments within the incandescent bulb.

A commonly used three-way incandescent bulb is rated at 50-100-150 watts of electrical consumption and proportional illumination. With the increasing costs of excessive electrical power consumption, more attention is being paid to the benefits of replacing incandescent light bulbs with energy-efficient ones. The major advantage of the compact fluorescent bulb over its incandescent equivalent is that it typically uses approximately 25% of the electricity consumed by the incandescent bulb for the same amount of light output.

It is possible, if not always easy, to find three-way compact fluorescent light bulbs. Anecdotal evidence suggests that there may be technical issues with the current generation of these bulbs, which would account for the difficulty sometimes encountered with finding them. The high cost of these bulbs may also tend to depress demand, and their subsequent availability.

When a “single-element” compact fluorescent or incandescent type of light bulb is used in a three-way lamp holder/switch, the sequence of illumination when rotating the switch's activating knob is “OFF-OFF-ON-ON,” which can be annoying to a consumer. This invention modifies that sequence to the more conventional “OFF-ON-OFF-ON”.

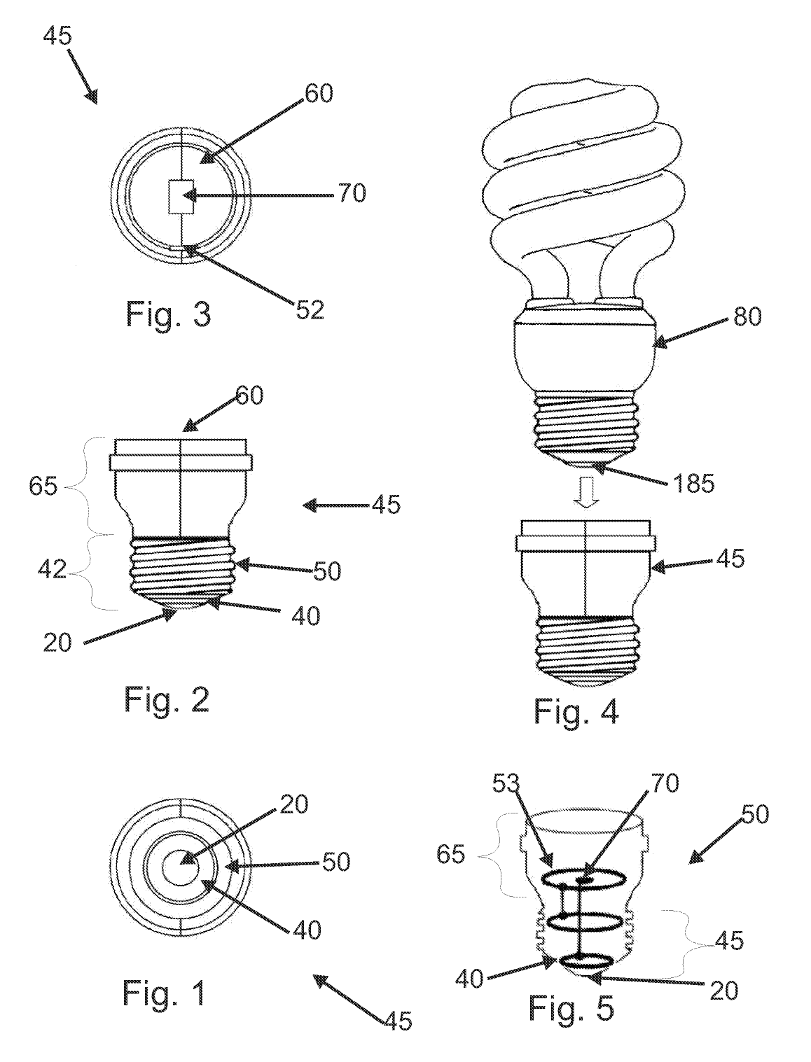

Referring to FIG. 1, the underside of an adapter 45 according to the principles of the present invention is shown; having a tip 20 connector made of a non-conductive material, a conductive a ring connector 40, and the common connector 50.

In one embodiment, and referring to FIG. 2, the adapter 45 is shown in side view, comprising a lower end with a modified three-way bulb base 42 having a tip 20, ring 40 and common 50 connection, and a one-way bulb socket 65 having an interior 60 into which a one-way bulb (not shown) may be inserted. Referring to FIG. 3, a top-down view of the adapter 45 is shown, revealing the interior 60 showing a single tip 70 connection and a common connection 52. The ring connection is absent. As may be seen in FIG. 4, a single-element one-way bulb 80 may be inserted into the adapter 45.

FIG. 5 reveals how the adaptation is accomplished. FIG. 5 shows an electrical schematic diagram of how the internal connections of the adapter are made. Of first note is that there is no electrical connection made to the tip 20. The ring 40 on the bulb base 42 is connected electrically to the tip connection 70 of the bulb socket 65. The common connection 50 of the base 42 is electrically connected to the common connection 53 of the socket 65.

Thus, the tip of a bulb 80 inserted into the socket 65 will be powered whenever the ring 40 of the base 42 is powered. Since there is no connection between the bulb 80 whatever to the tip 20, power applied to the tip 20 will have no effect on bulb illumination. The ring 40 of the base 42 is powered on low and high positions of the lamp switch (not shown) thus powering the tip 185 of a bulb 80 giving the desired off-on-off-on illumination sequence.

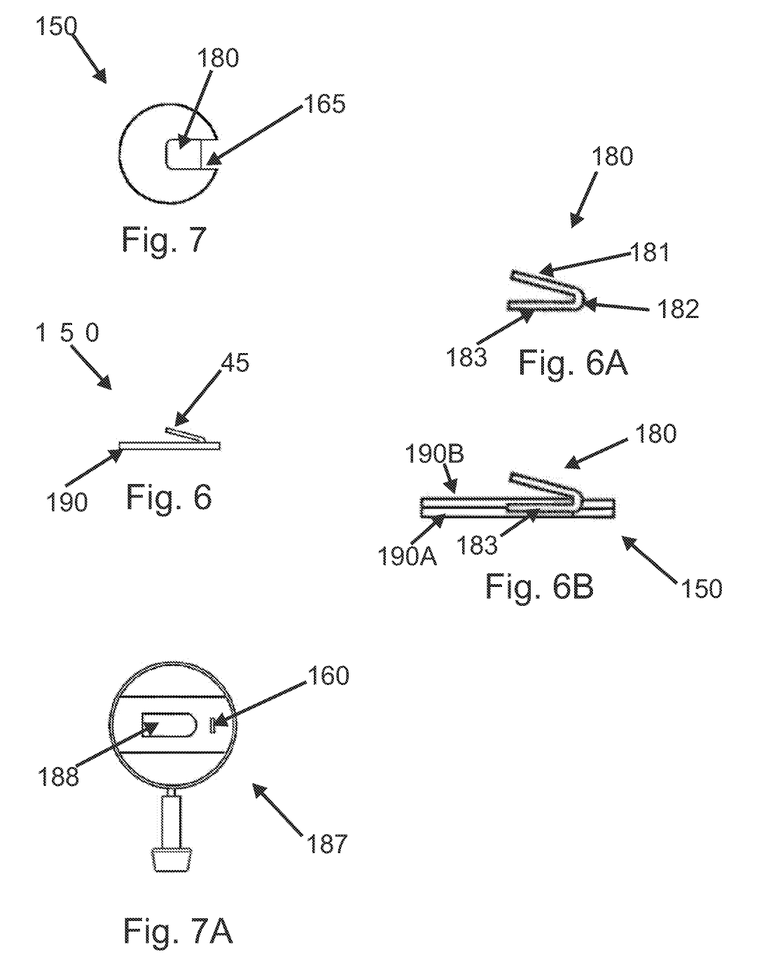

In a simpler embodiment, referring to FIG. 6, a side view of a button adapter 150 is shown. The adapter 150 is of a circumference designed to fit snugly into a standard three-way lamp socket. It has a body 190 made of a non-conductive stiff insulating material, such as high-temperature plastic or cardboard. As shown in FIG. 7, the adapter 150 has an index slot 165 to hold it in position over the ring connector 160 of a bulb base as shown in FIG. 7A.

Referring to FIG. 6A, an adapter connector means 180 part of the button adapter is shown disassembled from the button adapter. The adapter connector means 180 is made from a strip of conductive material bent into a roughly “J” shape, having a tip contact portion 181, a ring contact portion 182 and a neck portion 183. As shown in cutaway FIG. 6B, when assembled the neck portion 183 is sandwiched between the bottom 190A and top 190B of the body 190. The body may be made of two pieces as shown, or it may simply be of a material such as cardboard which is split so as to receive the neck portion 183 of the adapter connector means 180.

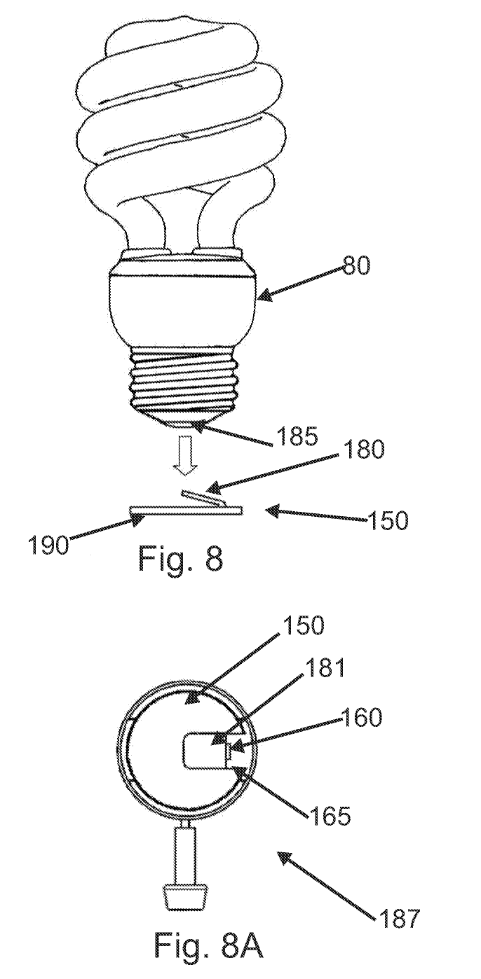

Thus, as shown in FIG. 7, on the top of the button adapter 150 the adapter connector means 180 is an electrically conductive contact designed to mate at the ring contact portion 181 with a ring connection 160 of a three-way lamp base 187 shown in top view in FIG. 7A (prior art) and with the tip contact 185 of a bulb 180 (prior art). Thus, as shown in FIG. 8A, when the button adapter 150 is inserted into a three-way lamp base 187 the adapter connector means 180 electrically connects through the ring contact portion 182 a ring contact 160 of a three-way lamp base 187, then through the tip contact portion 181 to a tip contact 185 of a one-way light bulb 80. The tip contact of the lamp base 188 is electrically isolated. As shown in FIGS. 7 and 8, the tip contact portion 181 of the adapter connector means 180 is in position so as to connect to a bulb tip contact 185 on a bulb 80. FIG. 8A shows a top view of a lamp base 187 showing the adapter 150 in place. As may be seen, the index notch 165 seats over the lamp base ring connector 160 electrically contacting the adapter ring contact portion 182 to the lamp base ring connector 160.

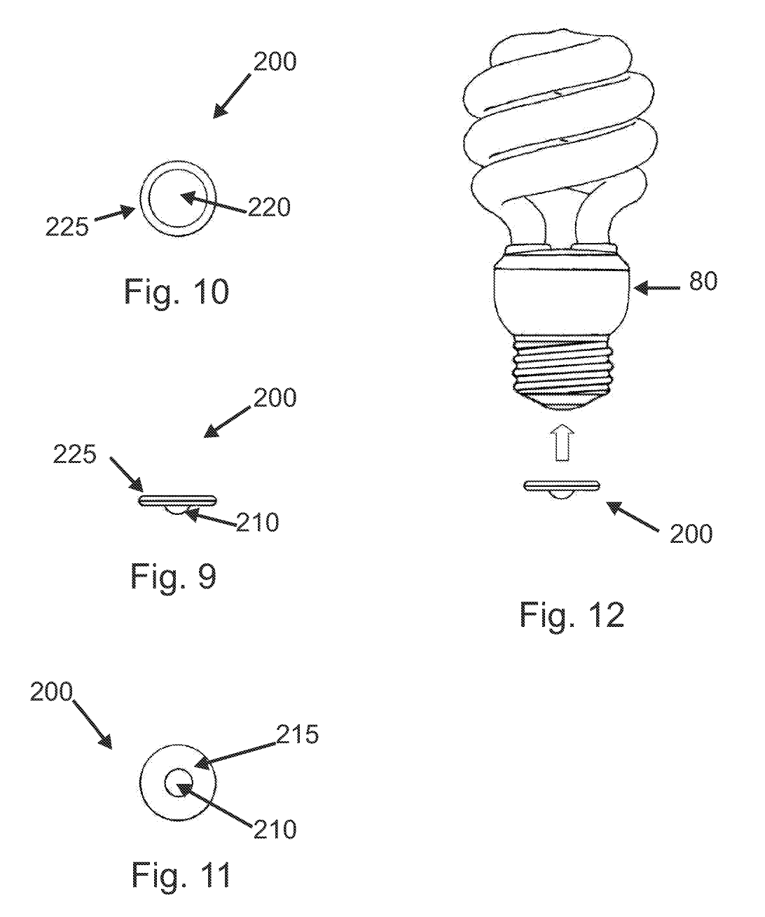

In yet another embodiment, shown in FIGS. 9 (side view), 10 (top view) and 11 (bottom view), an adapter 200 is shown having a rigid non-conductive frame 225, a non-conductive tip connector 210 on the bottom where it would non-electrically connect with the tip connector when installed in a lamp base (not shown). A conductive portion having a bottom 215 and top 220 is situated so as to engage on the bottom 215, when the adapter is inserted into a three-way lamp socket (not shown), with the lamp socket ring connection (not shown) and the top portion 220 would connect with the tip of a bulb 80 in FIG. 12 when inserted into a lamp base with the adapter 200 fitted therein. Typically, a three-way lamp socket ring connector is fabricated from a metallic spring strip designed to connect with the ring connection of a bulb base and to be compressed when the bulb is screwed into the lamp base. The non-conductive tip 210 of the adapter 200 is to be thin enough to allow the spring strip to make connection when a bulb 80 is screwed in a three-way base (not shown.) In use, the button adapter 200 is intended to be attached to the tip of a bulb 80, using a nonconductive adhesive so as to keep a consumer's fingers from being in the lamp socket during installation.

I claim:

1. A three-way to one-way light socket adapter comprising
a non-conductive body, said body comprising an upper portion and a lower portion; said lower portion comprising a modified three-way bulb base, said modified three-way bulb base comprising a base tip contact, a base ring contact and a base common contact; said upper portion comprising a one-way bulb socket, said one-way socket comprising a socket tip contact and a socket common contact;
said non-conductive body containing a first electrically-conductive connection between said base common connection and said socket common connection;
said non-conductive body further comprising a second electrically conductive connection between said base ring connection and said socket tip connection;
said base tip connection being electrically isolated from said one-way bulb socket.

2. A three-way to one-way light socket button adapter comprising a non-conductive disc-shaped body comprising an upper portion and a lower portion, said body being substantially circular and adapted so as to fit snugly into a three-way light bulb socket; said body further having a center;
said adapter further comprising adapter connector means, said adapter connector means having a tip contact portion, a ring contact portion and a neck portion;
said adapter further comprising a generally rectangular index notch adapted so as to fit over a ring connection in a three-way light bulb socket; said index notch having an inner edge;
the said neck portion being inserted between said upper portion and said lower portion of said body, said neck portion being positioned such that the ring contact portion as adjacent to said inner edge of said inner edge of said index notch and said tip contact portion protrudes above said body from said ring contact portion toward said center of said body;
the said index notch edge is a distance from the said center of said body such as will cause said ring contact portion of said adapter connector means when positioned in a three-way lamp socket to make electrically connect to a ring contact in a three-way lamp socket.

3. A three-way to one-way light socket button adapter comprising a non-conductive ring-shaped body, said body having a diameter sized so as to fit within a three-way light bulb socket; said body further having an interior generally circular and concentric connector portion comprised of a flexible electrically conductive material at least as large in diameter as the ring contact of a three-way light socket ring contact; said body having an underside center, said body further comprising a non-conductive pip attached to said underside center which said pip has a diameter sized so as to be able to cover a tip-connector of a three-way light socket; said interior conductive portion being adapted so as when inserted in a three-way bulb socket to electrically connect the ring connector of said three-way bulb socket with a tip connection on a one-way bulb when attached to the tip of a medium-based light bulb inserted into a three-way bulb socket.
